(19) United States
(12) Patent Application Publication
(10) Pub. No.: US 2021/0201707 A1
(43) Pub. Date: Jul. 1, 2021

(54) SELF PRIMING, RELEASABLE, WRAP-AROUND LABEL

(71) Applicant: CCL LABEL, INC., Framingham, MA (US)

(72) Inventor: Eric CUSHING, Riverside, CA (US)

(21) Appl. No.: 17/267,105

(22) PCT Filed: Aug. 20, 2019
(86) PCT No.: PCT/US19/47179

§ 371 Date: Feb. 9, 2021

Related U.S. Application Data
(60) Provisional application No. 62/719,879, filed on Aug. 20, 2018.

(51) Int. Cl. G09F 3/10; B32B 33/00; G09F 3/02

(52) U.S. Cl. CPC G09F 3/10; B32B 43/006; G09F 3/02; B32B 33/00

(57) ABSTRACT

A label having an imprint layer, a non-opaque layer, and a carrier layer is described. The label allows for printed information to be fixed to the outward-facing imprint layer. It is then removed from the carrier layer and applied to a curved surface so as to wrap completely around the object and overlap and adhere to itself over however many revolutions may be required. The trailing edge of this label can be selectively and non-destructively peeled away, and unwound to reveal the entire length of label and the printed content thereon, with its adhesive still being sufficient to allow the label to be rewound.

### CROSS-REFERENCE TO RELATED APPLICATIONS

This application claims priority to and benefit of U.S. Provisional Application No. 62/719,879 entitled “SELF PRIMING, RELEASABLE, WRAP-AROUND LABEL,” filed on Aug. 20, 2018, which is hereby incorporated by reference in its entirety.

### TECHNICAL FIELD

The present disclosure relates generally to labels. More specifically, a consumer-printable label applied to a small, cylindrical object is contemplated in which the printed portion of the label may be wound over itself, selectively unfurled to reveal the entirety of the printed portion, and then rewound/reapplied.

### BACKGROUND

On occasions, it may be desirable to apply a label to a small cylindrical object, but the circumference of the object is too small to accommodate the amount of label required to print whatever content is desired. As one, non-limiting example, a bottle or container holding a fluid may require detailed instructions on the fluid's use. However, owing to the small diameter of the bottle, the amount of printed content outstrips the physical size of the exposed area provided by the exposed surface area/circumference of the bottle.

As a result, a number of “extended content labels” labels have been developed. These labels may include folding panels and/or multi-page booklets, bonded at least along a periphery of the panel/booklet (usually to a longitudinal axis and one or more radial axes), thereby allowing the resulting label to conform to the surface of the bottle except when the user wishes to unfold or open it to read the content. While effective at accommodating increased amounts of surface area for printed material, these relatively extravagant arrangements are produced by way of specialized equipment requiring automated, multi-step assembly. Also, the expense and complexity of these assembly methods makes it difficult for someone needing extended content labels to rely on widely available, consumer-grade equipment (e.g., a printer associated with home computers and/or similar “desktop” type devices). Further still, some consumers may not find such arrangements to be intuitive, insofar as they require proper folding and/or positioning of the panels/booklets, and a failure of the bond along the periphery may cause the entire portion containing printed material to fall off or become unusable.

Separately, a number of other solutions for incorporating extended content are available to professional printing operations. For example, professionally produced “wraparound labels” use a flap that is wound around a cylindrical object so that, when unraveled, additional printed material (beyond that which could normally be printed on the cylindrical object's circumference) can be used. However, all of these known wraparound labels employ a clear release-coated over laminate deposited on the label after it has been printed. This over laminate protects the printed content from the overlapping adhesive, but it also entails significant cost and manufacturing complexities. Taken together, these costs and complexities make professional-style wraparound labels impractical for use by average consumers in need of a do-it-yourself solution based on common household equipment (e.g., a personal computer/tablet/mobile device and desktop printers). Thus, a need exists for a label, system, or method that can be adopted to employ labels to bottles or cylindrical containers in a manner that addresses the problems in the art. There is a particular need to print labels without professional assistance and subsequent additional laminate layer.

### SUMMARY

The disclosure described herein provides a novel extended content label capable of being printed with an average consumer-grade printer. The disclosed arrangement simply requires the consumer to ravel and unravel the label along an identical axis of rotation as the container to which it is affixed.

In function, a printable sheet is provided having a length that exceeds the circumference of the curved surface to which it will be applied. The label is peeled from a carrier or release liner and adhered to the curved object. In doing so, the label wraps completely around the object and onto an exposed outer facing of the label itself so as to overlap and stick to itself. This overlapping may occur over however many revolutions may be required.

The alignment of the label, as it is positioned on the object, avoids dog-ears or other unwanted, exposed sections which are not secured to the curved surface. The leading edge (i.e., the part of the label in direct contact with the object, and especially along its edge) is affixed to the object by way of a strong, primary adhesive having greater strength than the other adhesive(s) employed for the wraparound functionality.

The trailing edge can be lifted, non-destructively peeled away, and unwound from itself to reveal the entire length of label and the printed content thereon. The adhesive associated with this trailing edge is sufficient to allow the label to be released under sufficient peeling pressure and subsequently rewound. In combination with the primary adhesive on the leading edge, this arrangement enables unfurling of the label without damaging the label or the printed content to which it may adhere.

As noted above, this arrangement is executed relying on a label sheet that is appropriate for use with common desktop printers. The face stock of the label is capable of receiving ink from such printers, while the adhesives and other coatings/laminates in the label itself ensure that the printed label continues to function as intended even after repeated use and, more significantly, without the need for professional-style, costly clear coat laminates applied after the printing operation.

In an embodiment, provided is a label sheet comprising a releasable carrier layer, a non-opaque layer adhered directly to the carrier layer by a primary adhesive, and an imprint layer adhered directly to the non-opaque layer by a secondary adhesive. At least one label may be formed in an overlapping portion of non-opaque and imprint layers in the sheet. The primary adhesive may have a greater adhesive bonding strength than the secondary adhesive such that the primary adhesive possesses sufficient bonding strength to adhere to an object and the secondary adhesive possesses sufficient bonding strength to selectively separate the imprint layer from the non-opaque layer when the label is removed from the carrier layer, applied to wrap around an object, and then be at least partially unfurled from the object. The label includes a pull tab and the pull tab may not allow the first and second adhesives to be exposed when the label is removed from the sheet. A portion of the carrier layer may remain attached to the pull tab. The at least one label may be defined on the sheet by dye cuts. The label may encompass the entire carrier layer. The label sheet may be rolled around itself to create a roll of label stock. The label includes a first indicia and a second indicia printed along the imprint layer such that the label is configured to conceal the second indicia when wrapped around object and is configured to be selectively unfurled to reveal said second indicia.

In another embodiment, provided is a method of laminating a printed label, the method comprises providing label stock having an imprint layer with an outer facing side and an inner facing side and a non-opaque layer with a first side and an opposite second side, wherein the inner facing side of the imprint layer is adhered to the first side of the non-opaque layer with a first adhesive and the second side of the non-opaque layer includes a second adhesive such that the second adhesive has greater bonding strength than the first adhesive. At least one label may be formed in the label stock. The label stock my be processed through a printer device to apply a first indicia and a second indicia to the imprint layer. The label may be removed from the label stock. The label may be wound around an object so that the label wraps around at least a portion of itself and to cover at least a portion of the imprint layer. The label may be at least partially unfurled so that a longitudinal portion of the non-opaque layer separates from the inner facing side remains adhered to the outer facing side of the imprint layer to form a viewable portion of the imprint layer along the longitudinal portion. A first indicia and a second indicia may be provided to the at least one label on the label stock wherein the step of winding the label around the object includes concealing the second indicia and the step of unfurling the label includes revealing the second indicia. After the unfurling step, the label may be adhered or rewound/reattached around said object.

In another embodiment, provided is a selectively releasable label for application to a cylindrical substrate comprising a selectively separable, multi-layered laminate having a face layer exposed on one side, a liner layer exposed on the opposite side, and a laminate layer positioned therebetween. The face layer adheres to the laminate layer at a first adhesion force wherein the face layer and the laminate layers are removable from the liner layer such that the face layer and laminate layer are configured to be wrapped around a cylindrical substrate and, when so positioned, the laminate adheres to the cylindrical substrate at a second adhesion force while the label overlaps onto itself. The first adhesion force may be greater than the second adhesion force. The laminate layer may be configured to adhere to an exposed portion of the face layer at a third adhesion force when wrapped around said cylindrical substrate and the laminate layer adheres to the liner at a fourth adhesion force such that the second adhesion force is greater than the third adhesion force, and the third adhesion force is greater than the fourth adhesion force. The face layer and said laminate layer may each include a leading edge and an opposite trailing edge wherein a portion of the laminate layer adjacent the leading edge is configured to adhere to the cylindrical substrate and a portion of the laminate layer adjacent the trailing edge is configured to adhere to the face layer as the label is wrapped around the cylindrical substrate. The leading edge of said face layer and the leading edge of said laminate layer may be in alignment when wrapped around the cylindrical substrate such that the trailing edge of said face layer and the trailing edge of said laminate layer are in alignment when wrapped around the cylindrical substrate. The face layer may include a first indicia portion and a second indicia portion such that when wound along the cylindrical surface the first indicia portion is viewable and the second indicia portion is covered by a portion of the face layer. The face layer may be configured to be selectively unfurled from the laminate layer to reveal the second indicia portion along the face layer. The face layer may be configured to be selectively reapplied to the laminate layer along the cylindrical substrate to conceal said second indicia portion along the face layer. The second indicia portion along the face layer may be is viewable through the laminate layer. As the face layer is unfurled from the laminate layer to reveal the second indicia portion along the face layer, a portion of the laminate layer may remain adhered to an unfurled portion of the face layer.

Specific reference is made to any appended claims, drawings, and description below, all of which disclose elements of the disclosure. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the disclosure may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the disclosure as if fully rewritten herein.

In the drawings:

FIG. 1A is a top view of the label and curved object as the label is applied in its fully wound/overlapping state;

FIG. 1B is a top view of the label and curved object when the label is selectively unwound/unfurled;

FIG. 1C is a three dimensional perspective view of the curved object with the label applied thereto;

FIG. 2 illustrates a cross section of certain disclosed aspects when the label is first applied to a curved object in its fully wound/overlapping state along line a-a shown in FIG. 1A;

FIG. 3A illustrates a cross section of certain disclosed aspects when the label is affixed to the object along line b-b shown in FIG. 1B;

FIG. 3B illustrates a cross section of certain disclosed aspects when the label is affixed to its carrier layer;

FIG. 4 is a top plan view of an example of a label sheet with a plurality of labels according to certain aspects of the disclosure;

FIG. 5A is a top view of an embodiment of the label and object when the label is fully wound./overlapping state; and

FIG. 5B is a top view of the label of FIG. 5A when the label is selectively unwound/unfurled.

### DETAILED DESCRIPTION

Reference will now be made in detail to exemplary embodiments of the present disclosure, examples of which are illustrated in the accompanying drawings. It is to be understood that other embodiments may be utilized and structural and functional changes may be made without departing from the respective scope of the disclosure. As such, the following description is presented by way of illustration only and should not limit in any way the various alternatives and modifications that may be made to the illustrated embodiments and still be within the spirit and scope of the disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

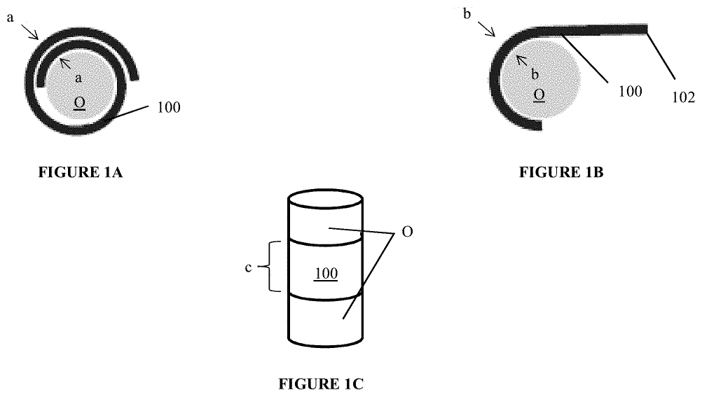

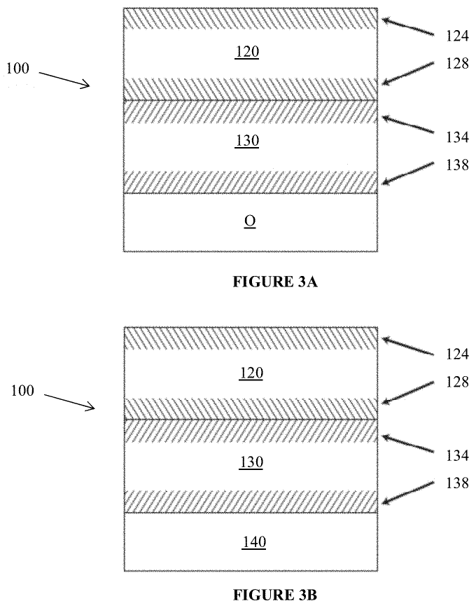

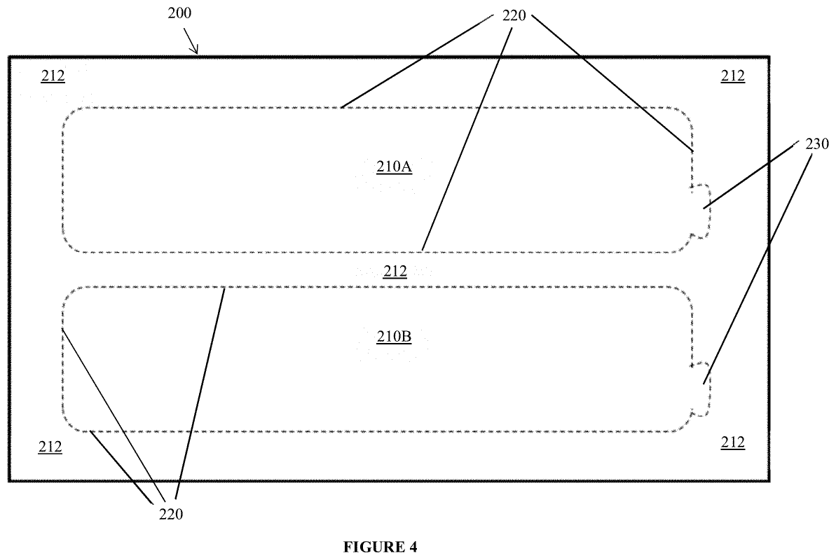

While FIGS. 1A through 3A illustrate various aspects of the label as it is expected to be applied to an object, it will be understood that a key advantage of the disclosure is that it may be executed using label stock as exemplified in FIGS. 3B and 4 that can be fed through common, desktop (or other consumer-oriented) printers, usually in combination with a personal computing device such as a laptop or desktop computer or even a tablet or mobile phone running appropriate software. Certain portions of the label stock will correspond to features of the label when it is applied to the object, and persons familiar with this field will recognize how these features align.

FIG. 1A shows a top view of label 100 according to certain disclosed aspects affixed to a curved object O. Use of the term “curved” throughout is relative, and the surface may incorporate significantly flat portions without departing from disclosed aspects herein. Also, although object O is shown as being circular, any number of differing cylindrical or polyhedral objects may be encompassed. For example, polygonal, regularly or irregularly curved, oval and/or other shapes having a plurality of curvedly, acutely, and/or obtusely disposed edges may be used. In preferred embodiments, the object O retains a substantially constant shape along the longitudinal portion c of the object O, as shown in FIG. 1C, to which the label 100 will be applied in order to simplify application of the label without wrinkling or bunching.

FIG. 1B shows a similar top view as in FIG. 1A, although FIG. 1B shows label 100 in an unfurled state. Trailing edge 102 of the label 100 is unwound from the curved surface so as to expose the entirety of the outer-facing surface of the label 100, which may include printed information as will be described in greater detail below. Leading edge 104, opposite from trailing edge 102 is illustrated as being affixed to the object O.

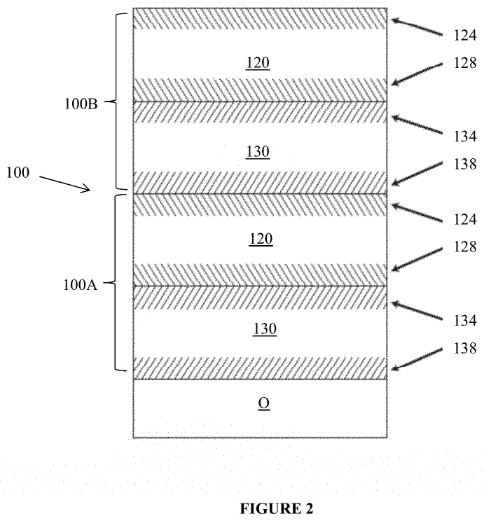

FIG. 2 is a cross section of the label 100 applied to a object O in its fully wound/overlapping state, as taken along the line a-a shown in FIG. 1A. Label 100 overlaps itself in this plane, so that discrete overlays 100A and 100B are shown. Although only a pair of overlays is illustrated, additional overlays are possible. The number of overlays will correlate to the amount of linear space required for printing, as well as the actual circumference of the object O.

Generally speaking, label 100 (and, more specifically in the context of FIG. 2, individual discrete overlays 100A and 100B) each comprise a two-layered structure. Layer 120 is an imprint layer. Imprint layer accommodates printed indicia on its outer facing surface 124. The printed indicia may be way of printer or handwriting, although other means may be contemplated (e.g., stamping, etching, etc.). The inner facing side of layer 120 comprises a secondary adhesive 128, preferably coated, impregnated, or otherwise applied or incorporated with layer 120. Adhesive 128 is sufficient to adhere and re-adhere to an additional, underlying portion of label 100.

Layer 130 of label 100 comprises a non-opaque layer or film. This layer 130 includes top or outer facing side 134 and inner facing, primary adhesive 138. Primary adhesive 138 will be comparatively stronger in comparison to adhesive 128. In an embodiment, the

As seen in FIG. 3A, once the label 100 is removed from carrier 140, it may be affixed to the outer facing surface of object O. In this arrangement, the primary difference is that label 100 now adheres to the object O. More specifically, in its first wrap around object O, the primary adhesive 138 attaches the label 100 to the object O. In subsequent wraps (as seen in FIG. 2), the primary adhesive ensures that a film 130 remains affixed to the imprint layer 120 to protect the printed indicia from becoming impaired. Secondary adhesive 128 acts to selectively couple and decouple the wraps. Specifically, the bonding strength of the primary adhesive is stronger than that of the secondary adhesive, so as to allow for the subsequent separation and delamination of the imprint and non-opaque layers after the label has been wound around itself and then unfurled. In this manner, the imprint layer becomes at least partially laminated along those portions in which it is subsequently unfurled, thereby protecting the printed indicia.

As seen in FIG. 3B, the label 100 is carried on a carrier layer 140. A user may remove the label 100 from carrier layer 140 once printed indicia have been disposed on layer 124. As will be described in more detail below, the label 100 and the carrier layer 140 effectively form a label sheet that remains attached so as to allow for handling, printing, and other manipulation of the label sheet.

The carrier layer 140 protects the primary adhesive 138 while the sheet is passed through a printer, in particular, a consumer-grade and/or desktop printer. The material for this carrier layer 140 can be any type of release liner. Silicones, waxes, fluorocarbons and other adherent materials are commonly incorporated in such release liners. The release value for this layer should be appropriate to the label and its anticipated use.

In some embodiments, the carrier 140 and its constituent part (layers 120, 130) can be provided in roll-form—rather than as a flat sheet—to enable more automated, commercial systems. However, the roll form would still incorporate the layers shown in FIG. 3B, with the primary difference being that the label sheet of FIG. 4 would be repeated along the longitudinal axis of the roll (or, alternatively, the dye cuts may be eliminated so that the entire roll may comprise the laminate of FIG. 3B).

FIG. 4 illustrates label sheet 200 according to certain aspects of the disclosure. As shown, dye cuts 220 define distinct labels 210A, 210B, as well as excess label stock 212. The dye cuts 220 enable a user to remove the labels 210A, 210B from the underlying release liner/carrier layer (not shown in FIG. 4). While two labels are shown, any number of labels—having similar or differing shapes—could be provided to sheet 200.

In some aspects, the labels 210A, 210B may incorporate an integral pull tab 230. Tab 230 may facilitate grasping the label once it is affixed to an object for the purposes of unfurling. If incorporated, the tab may take any appropriate shape. Tab may also omit adhesives or be engineered so that the release liner remains attached so as to allow the tab to be grasped when the label is affixed.

Suitable adhesives for layers 128, 138 may include pressure sensitive adhesives as well as others, for example, some gum-based adhesives that do not require activation. Pressure sensitive adhesives can include emulsion, hot melt, solvent-based, and/or ultraviolet-cured adhesives. Acrylic-based, rubber-based and silicone-based pressure sensitive adhesives can be used, as well as tackified pressure sensitive adhesives.

The imprint layer 120 may comprise any paper-based material. Specific, non-limiting examples include paper, cardboard, or one or more polymer materials, such as a polyester. Provided it possesses sufficient structural integrity to accomplish the other objects described herein (e.g., releasing as a single unit from layer 130), the imprint layer 120 may itself be a laminate comprising any combination of these materials.

The non-opaque layer 130 may comprise any common material known in the label field, with sufficient non-opaque polymers being preferred. In use, the non-opaque nature of layer 130 enables a consumer to visualize printed indicia that may be contained beneath layer 130, and it may be engineered to have properties similar to that of a release liner. More specifically, the non-opaque layer 130 adheres to the imprint layer 120 once the label is affixed in its wraparound state to as to serve as a protective, see-through overlay for the imprint layer 120.

Additional surface coatings, impregnation materials and the like can be incorporated into one or more of the aforementioned layers 120, 130, and 140. For example, a coating to facilitate the capture of printed material (e.g., by sufficiently absorbing ink), a release coating or agent to facilitate separation of the layers, and/a protective coating to resist or exclude moisture so as to avoid smudging of printed matter enclosed beneath the layer may be employed selectively along portions of the label 100 or in its entirety.

The trailing edge 102 of label 100 may be designed to have one or more grips, tabs, or similar structures (including the absence of adhesive and/or the use of lesser strength adhesive relative to the other adhesive incorporated elsewhere in label 100, including layers 128 and/or 138). The design simplifies the user's ability to grasp this edge so that label 100 can be more easily unfurled from the object O.

Besides sheet-fed printing and hand-applying, this disclosure could be deployed in a roll format. The disclosure encompasses both the label, as described herein, as well as form sheets and rolls. Dye-cuts and/or perforations can be employed to facilitate separation of the label from the sheet and/or roll.

In some embodiments, non-opaque layer 130 may be formed under only a portion of imprint layer 120, with the remaining portion of label 100 comprising only the imprint layer 120.

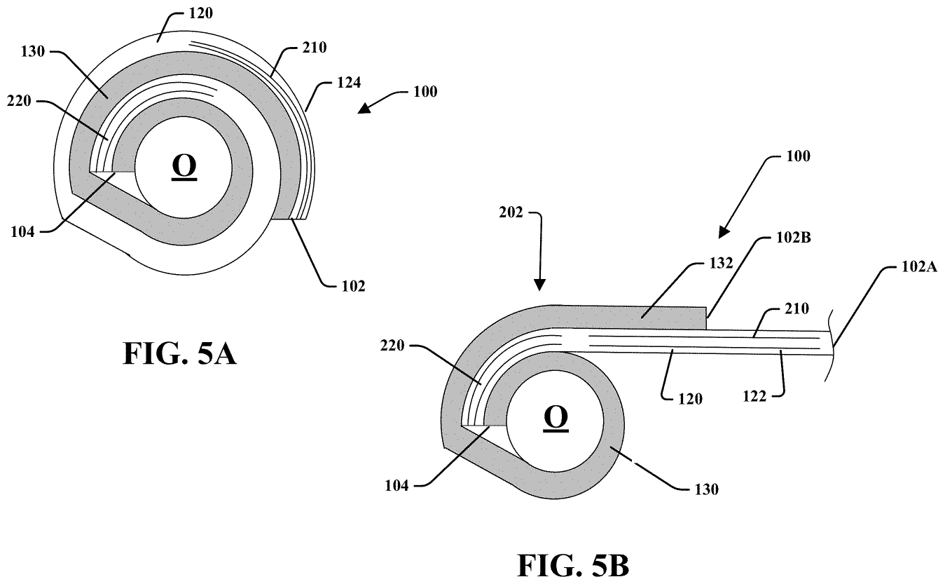

FIGS. 5A and 5B illustrate an embodiment of the label wherein layer 138 could be formulated so as to strongly and/or more permanently adhere to the surface to which it is applied on both the object O as well as portions of the top facing sides 124 of the imprint layer 120. FIG. 5A illustrates a top view of the label 100 including the imprint layer 120 and the non-opaque layer 130 wrapped around the object O. FIG. 5B illustrates a portion of the imprint layer 120 being unfurled from the non-opaque layer 130. In this manner, a first trailing edge 102A of the imprint layer 120 is separated from a second trailing edge 102B of the non-opaque layer 130 to allow further unfurling of the imprint layer 120. Longitudinal portions 132 of the non-opaque layer 130 remain adhered to the outer facing surface 124 of an unfurled portion 122 of the imprint layer 120 to effectively laminate portions of the outer facing, visible surface of the label 100 after it has been printed and applied to the object O. This configuration allows for a viewable portion 202 through the non-opaque layer placed along the imprint layer 120.

The outer facing surface 124 of the imprint layer may receive indicia printed thereon. The indicia may be any printed or applied subject matter viewable on a label as desired. In an embodiment, as illustrated by FIGS. 5A and 5B, the outer facing surface 124 may include a first indicia 210 and a second indicia 220. The second indicia 220 may be concealed by portions of the imprint layer 120 as it is wound around the object O (FIG. 5A) while the first indicia 210 remains viewable along the object O as the imprint layer 120 is adhered to the outer surface of the non-opaque layer 130. Once the imprint layer 120 has been at least partially unfurled from the non-opaque layer 130, as illustrated by FIG. 5B, the second indicia 220 is revealed as viewable about the surface of the object O. Here, both the second indicia 220 and the first indicia 210 are now viewable along the imprint layer 120 and a longitudinal portion 132 of the non-opaque layer 130 remains adhered to the unfurled portion 122 of the imprint layer 120.

A method for applying a label and for incorporating printed indicia onto a label and object is also contemplated. Here, a laminated label stock or sheet, substantially as described above, is provided. Printed indicia is then disposed on the imprint layer of the label stock/sheet, and an individual label is peeled from its carrier layer and wound around an object so that the trailing edge of the label overlaps with at least a portion of the leading edge of the label already adhering to the object (directly or indirectly). When this label is subsequently unwound, the non-opaque layer adheres to the outer-facing side of the imprint layer, thereby laminating the label.

Table 1 discloses one aspect of the disclosure. The peel adhesion between salient surfaces is disclosed under a variety of conditions. Notably, the most force is required to peel the laminate from its own facing, thereby preserving the integrity of the label. In comparison, the label has strong peel adhesion on common substrates, such as glass or high density polyethylene. The least amount of force involves peeling the face layer (imprint layer) from the laminate layer (non-opaque layer). While specific values are disclosed and contemplated, it will be further understood that ratios and relationships may be inferred from and inherent to the values disclosed in this table.

TABLE 1
Comparison of adhesive properties
under selected conditions.

| | Peel Adhesion at 90° |
|---|---|
| | and 12 inch/minute |
| | Average force - initial |
| Condition | (N/inch) |
| Label on glass substrate | 7.70 +/− 0.32 |
| Label on HDPE substrate | 6.74 +/− 0.84 |
| Face on laminate | 1.13 +/− 0.15 |
| Laminate on face | 9.79 +/− 0.89 |

Table 2 discloses the liner release force for the same label tested/described in table 1 above. Here, the release force (removing the laminate from the liner) is significantly lower than any of the values contemplated by the embodiments of Table 1. As above, it is possible to infer ratios and other relationships between the values of Table 2 and those disclosed in Table 1 above.

TABLE 2
Comparison of adhesive
properties upon release.

| | Liner Release at 90° |
|---|---|
| | Average force - initial |
| Condition | (N/inch) |
| First trial, laminate | 0.328 +/− 0.030 |
| to liner | |
| Second trial, laminate | 0.386 +/− 0.071 |
| to liner | |

In order for the disclosure to function, the following relationships exist: the force adhering the laminate to face is greater than that adhering the label to the substrate (surface of the object O). In turn the adhering force of label to substrate is greater than that required for the face to adhere to the laminate. Finally, the adhesion force of face to laminate is greater than that adhering the laminate to the liner. In this manner, the required furling and unfurling of the label around the cylindrical object/substrate can be maintained.

Thus, in the embodiment contemplated in Tables 1 and 2, the adhesion force of the laminate to the face is about 50% greater than the adhesion force required for the label to adhere to the substrate (e.g., the cylindrical surface or object O). In turn, the label to substrate force is five to six times greater than the adhesion forces holding the face to the laminate, while the face to laminate adhesion force is three to four times greater than that between the laminate to liner. In relation to the figures above, the face is similar to imprint layer 120 and the laminate is non-opaque layer 130 (or vice versa), while the substrate is similar to object O and liner is the carrier layer 140. Also, while specific values are identified for Tables 1 and 2, other individual and collective sets of values may be embraced in other aspects of the disclosure without departing from the principles described herein.

Although the present embodiments have been illustrated in the accompanying drawings and described in the foregoing detailed description, it is to be understood that the disclosure is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof

What is claimed is:

1. A label sheet comprising:
a releasable carrier layer;
a non-opaque layer adhered directly to the carrier layer by a primary adhesive;
an imprint layer adhered directly to the non-opaque layer by a secondary adhesive;
at least one label formed in an overlapping portion of non-opaque and imprint layers in the sheet; and
wherein the primary adhesive has greater adhesive bonding strength than the secondary adhesive such that the primary adhesive possesses sufficient bonding strength to adhere to an object and the secondary adhesive possesses sufficient bonding strength to selectively separate the imprint layer from the non-opaque layer when the label is removed from the carrier layer, applied to wrap around an object, and then be at least partially unfurled from the object.

2. The label sheet of claim 1, wherein the label includes a pull tab.

3. The label sheet of claim 2, wherein the pull tab does not allow the first and second adhesives to be exposed when the label is removed from the sheet.

4. The label sheet of claim 3, wherein a portion of the carrier layer remains attached to the pull tab.

5. The label sheet of claim 1, wherein the at least one label is defined on the sheet by dye cuts.

6. The label sheet of claim 1, wherein the label encompasses the entire carrier layer.

7. The label sheet of claim 6, wherein the label sheet is rolled around itself to create a roll of label stock.

8. The label sheet of claim 1, wherein the label includes a first indicia and a second indicia printed along the imprint layer such that the label is configured to conceal the second indicia when wrapped around object and is configured to be selectively unfurled to reveal said second indicia.

9. A method of laminating a printed label, the method comprising:
providing label stock having an imprint layer with an outer facing side and an inner facing side and a non-opaque layer with a first side and an opposite second side, wherein the inner facing side of the imprint layer is adhered to the first side of the non-opaque layer with a first adhesive and the second side of the non-opaque layer includes a second adhesive such that the second adhesive has greater bonding strength than the first adhesive;
forming at least one label in the label stock;
removing the label from the label stock;
winding the label around an object so that the label wraps around at least a portion of itself and to cover at least a portion of the imprint layer; and
unfurling the label so that a longitudinal portion of the non-opaque layer separates from the inner facing side remains adhered to the outer facing side of the imprint layer to form a viewable portion of the imprint layer along the longitudinal portion.

10. The method of claim 9 further comprising providing a first indicia and a second indicia to at least one label on the label stock wherein the step of winding the label around the object includes concealing the second indicia and the step of unfurling the label includes revealing the second indicia.

11. The method of claim 9 further comprising, after the unfurling step, adhering the label around said object.

12. A selectively releasable label for application to a cylindrical substrate comprising:
a selectively separable, multi-layered laminate having a face layer exposed on one side, a liner layer exposed on the opposite side, and a laminate layer positioned therebetween:
wherein the face layer adheres to the laminate layer at a first adhesion force;
wherein the face layer and the laminate layers are removable from the liner layer such that the face layer and laminate layer are configured to be wrapped around a cylindrical substrate and, when so positioned, the laminate adheres to the cylindrical substrate at a second adhesion force while the label overlaps onto itself; and
wherein the first adhesion force is greater than the second adhesion force.

13. The selectively releasable label of claim 12 wherein the laminate layer is configured to adhere to an exposed portion of the face layer at a third adhesion force when wrapped around said cylindrical substrate; and
wherein the laminate layer adheres to the liner at a fourth adhesion force such that the second adhesion force is greater than the third adhesion force, and the third adhesion force is greater than the fourth adhesion force.

14. The selectively releasable label of claim 12 wherein said face layer and said laminate layer each include a leading edge and an opposite trailing edge wherein a portion of the laminate layer adjacent the leading edge is configured to adhere to the cylindrical substrate and a portion of the laminate layer adjacent the trailing edge is configured to adhere to the face layer as the label is wrapped around the cylindrical substrate.

15. The selectively releasable label of claim 13 wherein said leading edge of said face layer and said leading edge of said laminate layer are in alignment when wrapped around the cylindrical substrate and wherein said trailing edge of said face layer and said trailing edge of said laminate layer are in alignment when wrapped around the cylindrical substrate.

16. The selectively releasable label of claim 12 wherein the face layer include a first indicia portion and a second indicia portion such that when wound along the cylindrical surface the first indicia portion is viewable and the second indicia portion is covered by a portion of the face layer.

17. The selectively releasable label of claim 16 wherein the face layer is configured to be selectively unfurled from the laminate layer to reveal the second indicia portion along the face layer.

18. The selectively releasable label of claim 17 wherein the face layer is configured to be selectively reapplied to the laminate layer along the cylindrical substrate to conceal said second indicia portion along the face layer.

19. The selectively releasable label of claim 17 wherein the second indicia portion along the face layer is viewable through the laminate layer.

20. The selectively releasable label of claim 17 wherein as the face layer is unfurled from the laminate layer to reveal the second indicia portion along the face layer, a portion of the laminate layer remains adhered to an unfurled portion of the face layer.
